(19) United States
(12) Patent Application Publication
(10) Pub. No.: US 2012/0305320 A1
(43) Pub. Date: Dec. 6, 2012

(54) Object Management Cabinet with Multi-Weighing Structure

(75) Inventor: Kuan-Hung Sun, Kaohsiung City (TW)

(73) Assignee: DIING LI TONG TECHNOLOGY CO, LTD., Kaohsiung City (TW)

(21) Appl. No.: 13/486,491

(22) Filed: Jun. 1, 2012

(30) Foreign Application Priority Data
Jun. 1, 2011 (TW) 100119166

(51) Int. Cl. G01G 19/00

(52) U.S. Cl. 177/25.13

(57) ABSTRACT

An object management cabinet with multi-weighing structure, which comprises a base, a weighing structure and a main control unit. The base is arranged for placing an object. The object has an RFID tag for transmitting object data. The weighing structure is arranged for measuring the object weight to produce measured data. The main control unit is arranged for matching the object data with the measured data to produce a match result.

### CROSS-REFERENCE TO RELATED APPLICATION

This application claims the benefit of Taiwan Patent Application No. 100119166, filed on Jun. 1, 2011, in the Taiwan Intellectual Property Office, the disclosure of which is incorporated herein in its entirety by reference.

### FIELD OF THE INVENTION

The present invention relates to an object management cabinet with multi-weighing structure, in particular to the object management cabinet capable of weighing one or more objects to calculate the consumption of the object.

### BACKGROUND OF THE INVENTION

As we know, chemicals are generally stored in a chemical storage cabinet in a laboratory for those who need the chemicals for experiments. After the chemicals are used, users put the chemicals back into the chemical storage cabinets. This approach may lead to a disordered arrangement of chemicals, because users may be unable to control and manage the chemicals effectively after use, or even let people carry some of the chemicals out from the laboratory for unauthorized or illegal use, and it is difficult to control and manage the use of the chemicals.

As a result, laboratory managers do not know the consuming condition of various types of chemicals and cannot control and manage the chemicals or resupply the chemicals, so that the next user may be trapped in an embarrassing situation of having no required chemical when needed. In addition, some chemicals are dangerous to our living environment and prohibited from carrying out from the laboratory, and their use is under government control. If such chemicals are carried out from a laboratory unintentionally or maliciously by any person, it may cause harms to our society and results in breaking the law and giving rise of all kinds of complex issues.

In view of the foregoing drawbacks of the prior art, the inventor of the present invention based on years of experience in the related industry conducted extensive researches and experiments, and finally disclosed an object management cabinet with multi-weighing structure to overcome the drawbacks of the prior art.

### SUMMARY OF THE INVENTION

In view of the shortcomings of the prior art, it is objective of the present invention to provide an object management cabinet with multi-weighing structure to control and manage the consumption condition of a specific object.

To achieve the foregoing objective, the present invention provides an object management cabinet with multi-weighing structure, comprising a base, a RFID tag, a weighing structure and a main control unit. The base includes an object placing space for containing an object, and the RFID tag transmits object data of the object. The weighing structure is installed at the bottom of the object placing space according to the position of the object placing space for measuring the weight of the object to generate measured data. The main control unit reads the object data and the measured data and matches the two data to generate a match result. The match result is stored into a built-in memory or a remote-storage system via a wired or wireless network.

In addition, the object management cabinet with multi-weighing structure further comprises a sensor to take an image of the object for identifying the object. Besides, the sensor can also sense the light shadow, the temperature, the humidity, or the position of the object.

Without departing from the technical area of the present invention, the invention can be implemented according to the following embodiments to overcome the aforementioned drawbacks of the prior art.

To achieve the objective of the present invention, the present invention also provides an object management cabinet with multi-weighing structure, comprising a base, a weighing structure and a main control unit. The base includes an object placing space for containing an object, and a RFID tag installed on a side of the object for transmitting object data corresponding to the object. The weighing structure is installed at the bottom of the object placing space according to the position of the object placing space. The weighing structure measures the weight of the object to generate measured data. The main control unit reads the object data and the measured data and matches the two data to generate a match result.

The present invention further provides an object management cabinet with multi-weighing structure, comprising a base, a weighing structure and a main control unit. The base includes an object placing space for containing an object, and a RFID tag installed on a side of the object for transmitting object data of corresponding to the object. In addition, a reader is installed on a side of the object placing space for reading the object data. The weighing structure is installed at the bottom of the object placing space according to the position of the object placing space. The weighing structure measures the weight of the object placed in the placing space to generate measured data. The main control unit reads the object data and the measured data from the reader and the weighing structure respectively and compares the two data to generate a match result.

The present invention provides an object management cabinet with multi-weighing structure, comprising a base, a weighing structure and a main control unit. The base comprises an object placing space for containing an object, and a RFID tag installed on a side of the object placing space. The RFID tag includes object data corresponding to the object and the first position data corresponding to the object placing space. The weighing structure is installed in the base and disposed at the bottom of the object placing space according to the position of the object placing space. The weighing structure is provided for measuring the weight of the object to generate measured data. In addition, the weighing structure includes the built-in second position data corresponding to the object placing space. The main control unit receives the object data and the measured data and matches the first position data and the second position data to generate a match result.

The present invention provides an object management cabinet with multi-weighing structure, comprising a base, a weighing structure and a main control unit. The base includes an object placing space for containing an object. The weighing structure is installed in the base and disposed at the bottom of the object placing space according to the position of the object placing space. The weighing structure is provided for measuring the weight of the object to generate measured data, and the weighing structure includes built-in position data corresponding to the object placing space. The main control unit includes built-in corresponding data of the object and the object placing space, matches the position data with the corresponding data and receives the measured data to generate a match result.

Therefore, the object management cabinet with multi-weighing structure has the following advantages:

(1) The object management cabinet with multi-weighing structure can record the consumption of the object by the weighing structure in order to show the consumption of the object.

(2) The object management cabinet with multi-weighing structure can record the consumption of the object by the weighing structure in order to remind a manager about the timing for resupplying the object.

The detailed description of following preferred embodiments is given below to make it easy for our examiner to understand the technical characteristics and effects of the present invention.

### BRIEF DESCRIPTION OF THE DRAWINGS

FIG. 1 is a schematic view of an object management cabinet with multi-weighing structure in accordance with the first preferred embodiment of the present invention;

FIG. 2 is a block diagram of an object management cabinet with multi-weighing structure in accordance with the first preferred embodiment of the present invention;

FIG. 3 is a block diagram of an object management cabinet with multi-weighing structure in accordance with the second preferred embodiment of the present invention;

FIG. 4 is a diagram showing a comparison of positions of an object management cabinet with multi-weighing structure of the present invention;

FIG. 5 is a block diagram of an object management cabinet with multi-weighing structure in accordance with the third preferred embodiment of the present invention;

FIG. 6 is a block diagram of an object management cabinet with multi-weighing structure in accordance with the fourth preferred embodiment of the present invention; and

FIG. 7 is a diagram showing a change of the weight of an object management cabinet with multi-weighing structure of the present invention.

### DESCRIPTION OF THE PREFERRED EMBODIMENTS

The technical characteristics and contents of the present invention will become apparent with the following detailed description and related drawings. It is noteworthy to point out that same numerals are used for representing respective same elements in the drawings.

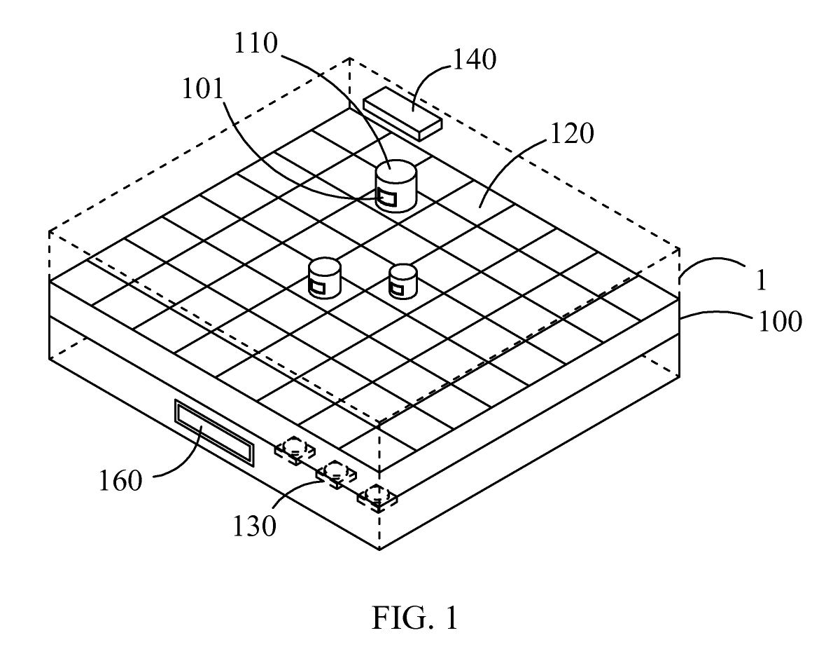

With reference to FIG. 1 for a schematic view of an object management cabinet with multi-weighing structure in accordance with the first preferred embodiment of the present invention. The object management cabinet with multi-weighing structure 1 comprises a base 100 having a plurality of placing spaces 120 for placing an object 110. A RFID tag 101 is installed on an external side of the object 110, and the RFID tag includes object data readable by a main control unit 140, wherein the main control unit 140 can be installed at the top of the object management cabinet with multi-weighing structure 1 for reading the object data in the RFID tag 101 from different directions. The base 100 further includes a plurality of built-in weighing structures 130, each being installed at the bottom of the object placing space 120 and provided for measuring the weight of the object 110 in the object placing space 120. A display unit 160 is installed outside the object management cabinet with multi-weighing structure 1 for displaying the result of the weight of the object measured by the weighing structure 130.

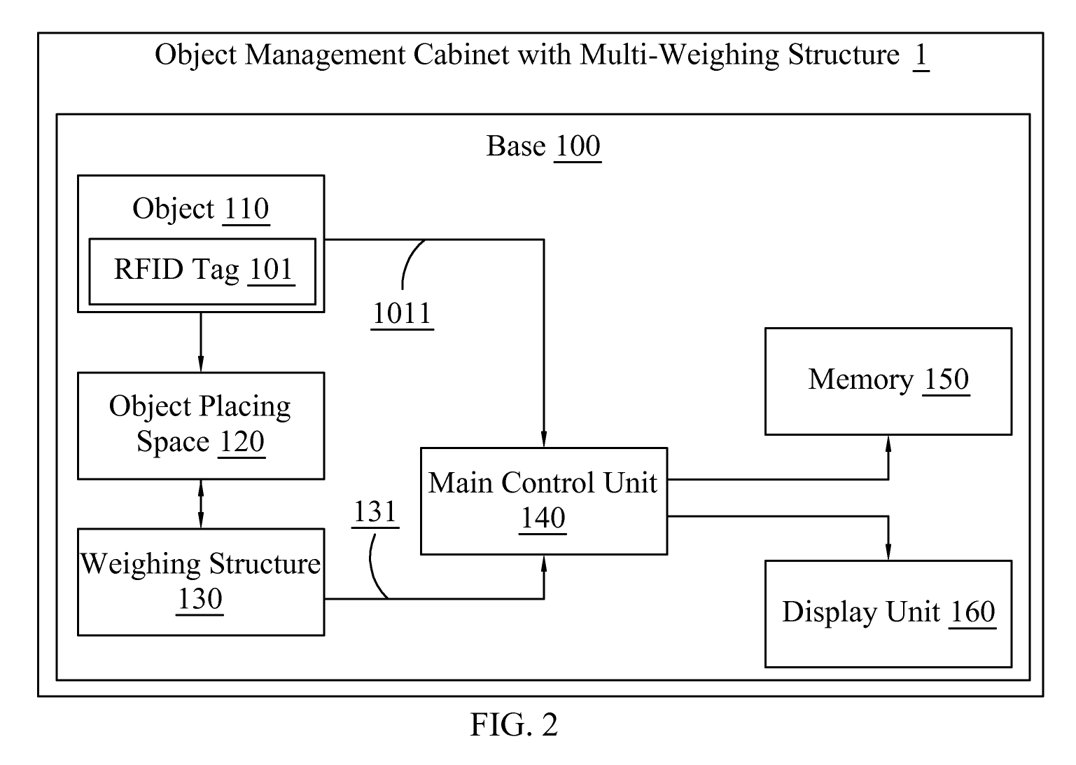

With reference to FIG. 2 for a block diagram of an object management cabinet with multi-weighing structure in accordance with the first preferred embodiment of the present invention, the object management cabinet with multi-weighing structure 1 comprises a base 100, a weighing structure 130 and a main control unit 140. The base 100 includes an object placing space 120 for containing an object 110, and a RFID tag 101 installed on a side of the object 110 for transmitting object data 1011, wherein the object data 1011 are used for representing various product data of the object 110 such as the type, feed-in date and delivery data of the object 110. The weighing structure 130 corresponding to the object placing space 120 is installed in the base 100. More specifically, the weighing structure 130 is installed at the bottom of the object placing space 120 according to the position of the object placing space 120. The weighing structure 130 is provided for measuring the weight of the object 110 to produce measured data 131. The main control unit 140 receives the object data 1011 and the measured data 131 and matches the two data to generate a match result. The measured data 131 further includes position data of the object placing space 120, and the main control unit 140 records the position of the object 110 according to the position data. Further, the main control unit 140 can perform a match according to the direction of receiving the object data 1011 and the position of producing the measured data 131 to find out the type and weight of the object 110. In addition, the object management cabinet with multi-weighing structure 1 further comprises a built-in memory 150 provided for the main control unit 140 to store the match results. A display unit 160 is installed outside the object management cabinet with multi-weighing structure 1 for displaying the match result stored by the main control unit 140 in the memory 150. The main control unit 140 can access the match result of the object 110 from the memory 150 and the object data 1011 and the measured data 131 of object 110 for another matching to obtain another match result, so as to calculate the consumption of the object 110. Therefore, a change of the weight of the object 110 can be used by a manager of the object 110 to know about the consumption of the object 110.

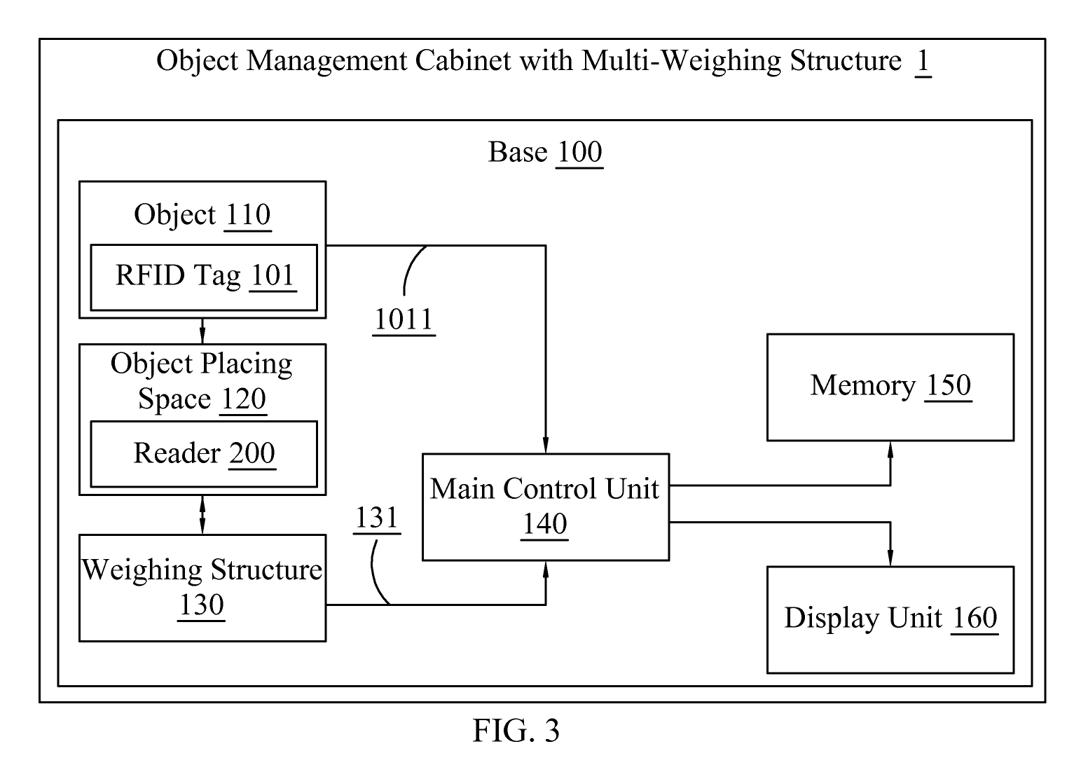

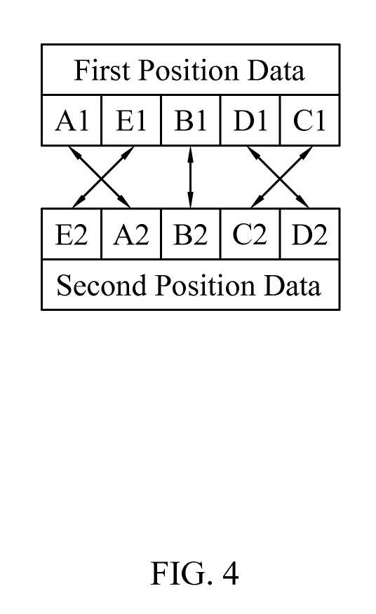

With reference to FIG. 3 and FIG. 4 for a block diagram of an object management cabinet with multi-weighing structure in accordance with the second preferred embodiment of the present invention and a comparison of positions of the object management cabinet with multi-weighing structure respectively, the object placing space 120 as shown in FIG. 3 includes a reader 200 installed on a side of the object placing space 120 for reading the object data 1011. The reader 200 reads a RFID tag 101 installed on the object 110 and transmits the object data 1011 to the main control unit 140. If the weighing structure 130 senses a difference between the weight of the object 110 and the weight previously recorded in the memory 150, or the weight of the object 110 not originally measured by the weighing structure 130 but sensed later, then the reader 200 will be turned on to trigger the RFID tag 101. The main control unit 140 receives the object data 1011 and the measured data 131 from the reader 200 and the weighing structure 130 respectively to compare the two data to generate a match result. The reader 200 includes the built-in first position data corresponding to the object placing space 120, and the reader 200 is provided for transmitting the first position data to the main control unit 140 and allowing the main control unit 140 to recognize the position of the object 110. In FIG. 4, the reader 200 includes the built-in first position data (A1, B1, C1, D1 and E1), and the measured data 131 includes the second position data (A2, B2, C2, D2 and E2), such that when the main control unit 140 receives the first position data and the second position data, a matching is performed according to matching characteristics. For example, A1 matches with A2, and B1 matches with B2, etc. The first position data and the second position data can be used for matching the object 110 and the measured result of its weight, so that the manager of the object 110 knows about the type and the weight of the object 110 for sure. The main control unit 140 can store the match result into the memory 150, and the display unit 160 can display the match result. The main control unit 140 can access the match result of the object 110 from the memory 150 and the object data 1011 and the measured data 131 of the object 110 for another match to obtain another match result, so as to calculate the consumption of the object 110. Therefore, a change of the weight is calculated, such that the manager of the object 110 can know about the consumption of the object 110.

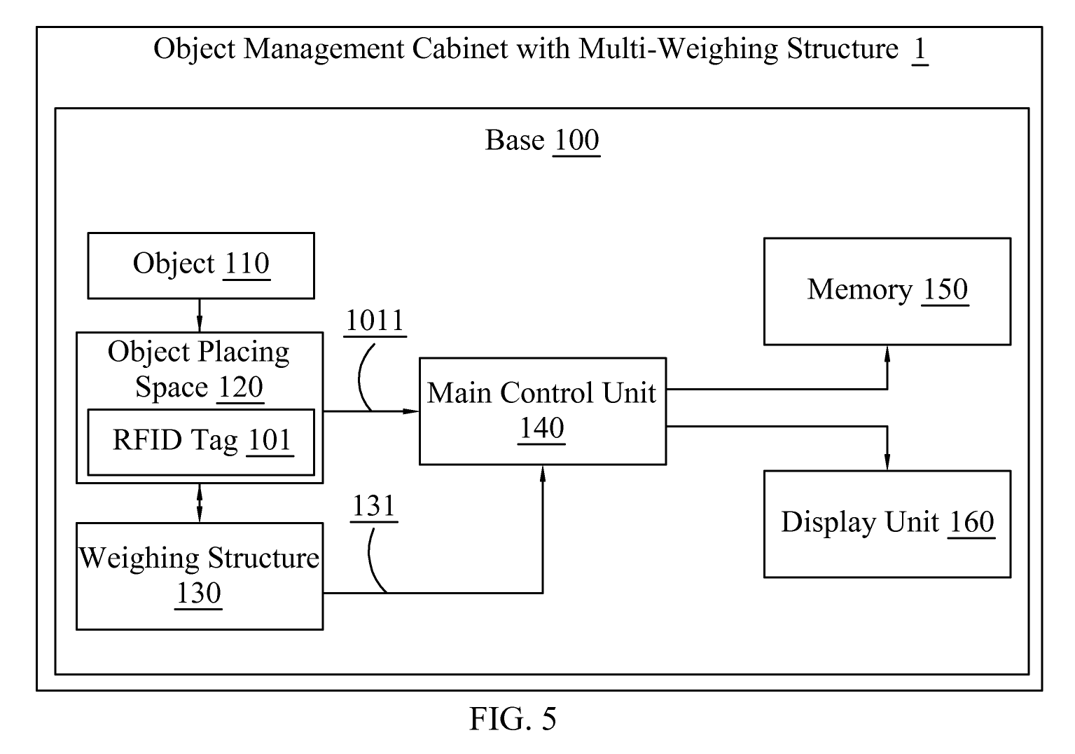

With reference to FIG. 5 for a block diagram of an object management cabinet with multi-weighing structure in accordance with the third preferred embodiment of the present invention, the object management cabinet with multi-weighing structure 1 includes a base 100. The base 100 includes a plurality of object placing spaces 120. A RFID tag 101 is installed on a side of the placing spaces 120. The RFID tag 101 includes the object data corresponding to the object 110 and the first position data corresponding to the object placing space 120. The weighing structure 130 includes the built-in second position data corresponding to the object placing space 120. The main control unit 140 is provided for receiving the object data 1011 and the measured data 131 and matching the object data 1011 and the measured data 131 according to the first position data and the second position data to generate a match result, and storing the match result into the memory 150, so that the display unit 160 can display the match result. The main control unit can access the match result of the object 110 from the memory 150 and the object data 1011 and the measured data 131 of the object 110 for another match to obtain another match result, so as to calculate the consumption of the object 110. Therefore, the weight change is calculated, and the manager of the object 110 can know about the consumption of the object 110.

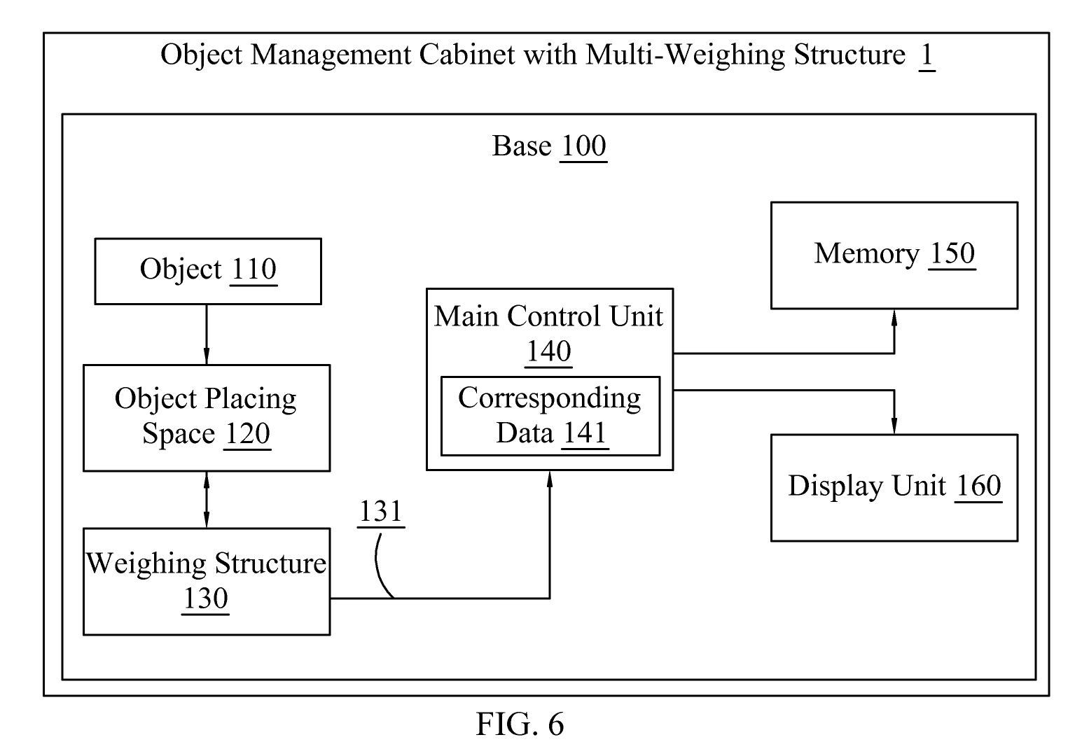

With reference to FIG. 6 for a block diagram of an object management cabinet with multi-weighing structure 1 in accordance with the fourth preferred embodiment of the present invention, the weighing structure 130 includes built-in position data corresponding to the object placing space 120. The main control unit 140 includes built-in corresponding data 141 corresponding to one of the objects 110 and the object placing space 120, and the main control unit 140 receives the measured data 131, and compares the position data and the corresponding data 141 to generate a match result.

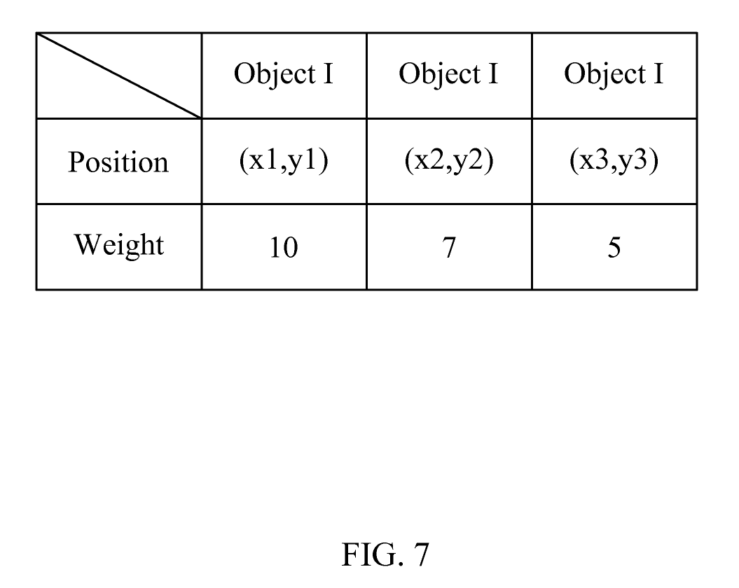

With reference to FIG. 7 for a diagram showing a change of the weight of an object management cabinet with multi-weighing structure of the present invention, a memory includes a plurality of records of the weight of the object, and the records of the object represent a weight change of a specific object. The main control unit compares two adjacent records of the weight of the object to obtain a weight change of a specific object, and the weight change is provided for the manager of the object to learn about the change of the consumption of the object. The manager of the object can determine whether or not the consumption of the object is abnormal according to the change of the consumption or determine whether or not the object is exhausted and requires replenishment. In FIG. 7, the weight change is equal to 10, 7 and 5 after the object I is recognized, and its positions have coordinates of (x₁, y₁), (x₂, y₂) and (x₃, y₃) respectively. The object position can be embedded into the weighing structure. If the position of the object placed in the base is fixed, the coordinates (x₁, y₁), (x₂, y₂) and (x₃, y₃) are the same, and the main control unit just needs to compare each record of the object weight to learn about the consumption of the object I. If the position of the object placed in the base is variable, the coordinates (x₁, y₁), (x₂, y₂) and (x₃, y₃) of the object may not be the same. Now, it is necessary to use additional position data built in the RFID tag for the comparison to obtain the consumption of the object I.

Optional, each of the above mentioned embodiments, which is a life cycle management cabinet, further comprises a sensor to take an image of the object for further identifying the object. Besides, the sensor can also sense the light shadow, the temperature, the humidity, or the position of the object. Optional, each of the above mentioned memory 150 storing the match result can be built in the object management cabinet with multi-weighing structure or set in a remote system such as a cloud system. If the memory 150 is set in a cloud system, the match result is transmitted to the memory 150 via a wired or wireless network.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An object management cabinet with multi-weighing structure, comprising:
a base having an object placing space for containing an object;
a RFID tag transmitting object data of the object;
a weighing structure installed at the bottom of the object placing space according to position of the object placing space and measuring object weight to generate measured data; and
a main control unit reading the object data and the measured data to generate a match result.

2. The object management cabinet with multi-weighing structure as recited in claim 1, further comprising a memory for the main control unit to store the match result, wherein the main control unit accesses the match result of the object in the memory to match the object data and the measured data of the object for another time to obtain another match result to calculate consumption of the object.

3. The object management cabinet with multi-weighing structure as recited in claim 1, wherein the main control unit recognizes the position of the object according to a direction of transmitting the object data.

4. The object management cabinet with multi-weighing structure as recited in claim 1, further comprising a reader having built-in first position data representing the object placing space, wherein the reader transmits the first position data to the main control unit to recognize the position of the object.

5. The object management cabinet with multi-weighing structure as recited in claim 4, wherein the measured data includes second position data corresponding to the weighing structure for the main control unit to recognize position of the weighing structure.

6. The object management cabinet with multi-weighing structure as recited in claim 5, wherein the main control unit matches the object and the result of weight measuring according to the first position data and the second position data.

7. The object management cabinet with multi-weighing structure as recited in claim 4, wherein the reader is turned on to trigger the RFID tag after the weighing structure senses the weight of the object.

8. The object management cabinet with multi-weighing structure as recited in claim 1, wherein the RFID tag is attached onto the object or onto a side of the object placing space of the base.

9. An object management cabinet with multi-weighing structure, comprising:
a base including an object placing space for containing an object;
a weighing structure installed at the bottom of the object placing space according to position of the object placing space and measuring weight of the object to generate measured data, and the weighing structure having built-in position data corresponding to the object placing space; and
a main control unit including built-in corresponding data of the object and the object placing space, and the main control unit receiving the measured data and matching the position data and the corresponding data to generate a match result.

10. The object management cabinet with multi-weighing structure as recited in claim 9, further comprising a memory for the main control unit to store the match result, wherein the main control unit accesses the match result of the object in the memory to match the object data and the measured data of the object for another time to obtain another match result to calculate consumption of the object.
